(19) United States
(12) Patent Application Publication
(10) Pub. No.: US 2022/0216666 A1
(43) Pub. Date: Jul. 7, 2022

(54) MULTIMODE INTERFERENCE EFFECT-BASED WIDE TUNABLE SINGLE-FREQUENCY OPTICAL FIBER LASER

(71) Applicant: SOUTH CHINA UNIVERSITY OF TECHNOLOGY, Guangzhou (CN)

(72) Inventors: Changsheng YANG, Guangzhou (CN); Shanhui XU, Guangzhou (CN); Linhuan HUANG, Guangzhou (CN); Zhongmin YANG, Guangzhou (CN); Zhouming FENG, Guangzhou (CN)

(73) Assignee: SOUTH CHINA UNIVERSITY OF TECHNOLOGY, Guangzhou (CN)

(21) Appl. No.: 17/608,482

(22) PCT Filed: Oct. 28, 2019
(86) PCT No.: PCT/CN2019/113789

§ 371 Date: Nov. 3, 2021

(30) Foreign Application Priority Data
Jun. 5, 2019 (CN) 201910488380.0

(51) Int. Cl. H01S 3/106; H01S 3/067

(52) U.S. Cl. CPC H01S 3/1062; H01S 3/06716; H01S 3/06791; H01S 3/0675

(57) ABSTRACT

Disclosed is a multimode interference effect-based wide tunable single-frequency optical fiber laser device. The laser device comprises a high-reflectivity chirped optical fiber grating, a high-gain optical fiber, a low-reflectivity chirped optical fiber grating, a pump source, an optical circulator, an optical fiber etalon and an SMS optical fiber structure apparatus. The high-reflectivity chirped optical fiber grating, the high-gain optical fiber and the low-reflectivity chirped optical fiber grating are connected in sequence to form a short linear resonant cavity; the optical circulator, the optical fiber etalon and the SMS optical fiber structure apparatus form a ring cavity, a stress loader is fixed onto the SMS optical fiber structure apparatus, and a transmitting wavelength of the SMS optical fiber structure apparatus is changed and tunable filtering by the SMS optical fiber structure apparatus is realized by loading stress to the SMS optical fiber structure apparatus.

### TECHNICAL FIELD

The present invention belongs to the technical field of optical fiber laser devices, in particular to a multimode interference effect-based wide tunable single-frequency optical fiber laser device.

### DESCRIPTION OF RELATED ART

The tunable single-frequency optical fiber laser device is a very important laser light source and has important application value in the fields of optical communication, sensing, spectroscopy and the like. A common tuning principle lies in that transmissive length is changed by some apparatuses to change the outputs wavelength of the laser device. Currently used tuning apparatuses such as a volume grating, a birefringent filter, an electro-optical crystal and a Fabry-Perot (F-P) etalon are inserted into a linear cavity, a ring cavity or a compound cavity to realize output of tunable single-frequency laser light. However, these ways have defects of full optical fiber structure breakage, large volume, spatial alignment requirement, high cost and the like. In addition, there are still problems that it is prone to jumping to multi-longitudinal modes, discontinuous in tuning range, poor in reliability and the like. Thus, there is an urgent need for tunable mode which is low in loss, full in optical fiber, compact in structure and easy to be coupled with optical fibers, so that single-frequency optical fiber laser light output with high reliability and wide tuning range is realized.

There are related patents: (1) in 2015, South China University of Technology filed an application: a wide tunable single-frequency optical fiber laser light source for a coherent light orthogonal frequency division multiplexing system. A tunable F-P filter is inserted into a ring cavity outside a linear resonant cavity, and a wide tunable single-frequency optical fiber laser device is realized [publication number: CN 105428973 A]. However, the tunable filter used in the patent is relatively high in cost and the tuning bandwidth and precision are limited to the filter itself; (2) in 2017, Fujian Hitronics Technologies Inc. has filed an application: a tunable laser device. The transmissive wavelength is changed by changing an angle of the F-P etalon, and the tunable laser device which is conveniently operated is realized [publication number: CN 206611012 U]. However, the patent is not the optical fiber laser device, it is hard to perform collimating work, and does not has a single-frequency laser light output characteristic. (3) in 2018, Nanjing University of Posts and Telecommunications has filed an application: a tunable optical fiber laser device. A single mode optical globule and a special optical fiber globule are welded between a single mode optical fiber and a special optical fiber to form a peanut knot structure, so that a mode-selecting thermal tunable full optical fiber laser device is realized [publication number: CN 208045931 U]. However, the patent does not have a single-frequency laser output characteristic and is complex to operate.

### SUMMARY

It is thereof an objective of the present invention to disclose a multimode interference effect-based wide tunable single-frequency optical fiber laser device to overcome defects in the prior art. The present invention adopts a compound cavity in combination with a self-injected locking structure. A high-reflectivity chirped optical fiber grating and a low-reflectivity chirped optical fiber grating and a centimeter magnitude high-gain optical fiber form a short linear resonant cavity portion, an optical circulator, an optical fiber etalon and an SMS optical fiber structure apparatus form a ring cavity, and a stress loader is fixed onto the SMS optical fiber structure apparatus. Under a pumping action of a pump source and a frequency-selecting action of an optical fiber grating, a resonant cavity of the high-gain optical fiber realizes broad spectrum laser light output first. A part of broad spectrum laser light enters the ring cavity. On the one hand, comb spectrum laser light is generated by using the optical fiber etalon, and on the other hand, deformation such as stretching, compressing, bending and twisting are applied to the multi-mode optical fiber by loading stress to the SMS optical fiber structure apparatus. The transmissive wavelength of the SMS optical fiber structure apparatus is changed and the tunable filtering of the SMS optical fiber structure apparatus is realized by changing interference among a plurality of transverse modes, so that single wavelength laser light is selected; and then, the laser light is injected to return to the resonant cavity to inhibit oscillation of other wavelengths and compress the linewidth narrow to form single longitudinal mode (single-frequency) laser light, and finally, the single-frequency optical fiber laser output with stable power and wide tuning range is realized.

The objective of the present invention is at least realized by one of the technical schemes as follows:

A multimode interference effect-based wide tunable single-frequency optical fiber laser device includes a high-reflectivity chirped optical fiber grating, a high-gain optical fiber, a low-reflectivity chirped optical fiber grating, a pump source, an optical wavelength division multiplexer, an optical coupler, an opto-isolator, an optical circulator, an optical fiber etalon, an

SMS optical fiber structure apparatus and a stress loader, wherein one end of the high-gain optical fiber is connected with one end of the high-reflectivity chirped optical fiber grating, another end of the high-gain optical fiber is connected with one end of the low-reflectivity chirped optical fiber grating, and the three form a short linear resonant cavity portion; a pump end of the optical wavelength division multiplexer is connected with a tail fiber of the pump source, a public end of the optical wavelength division multiplexer is connected with another end of the low-reflectivity chirped optical fiber grating, a signal end of the optical wavelength division multiplexer is connected with an input end of the optical coupler, a large output port of the optical coupler is connected with a port a of the optical circulator, a port b of the optical circulator is connected with an input end of the optical fiber etalon, an output end of the optical fiber etalon is connected with one end of the SMS optical fiber structure apparatus, another end of the SMS optical fiber structure apparatus is connected with a port c of the optical circulator, the stress loader is fixed onto the SMS optical fiber structure apparatus, a small output port of the optical coupler is connected with an input end of the opto-isolator, and finally, optical fiber light generated by the short linear resonant cavity is output via the output port of the opto-isolator, wherein the optical circulator, the optical fiber etalon and the SMS optical fiber structure apparatus form a ring cavity so as to form a compound cavity structure with the short linear resonant cavity in a self-injected locking form.

Further, the high-reflectivity chirped optical fiber grating has a transmissivity greater than 80% to a wavelength of pump light and a reflectivity greater than 80% to a wavelength of signal light, and 3 dB bandwidth of a reflective spectrum is 1-200 nm; and the low-reflectivity chirped optical fiber grating has a reflectivity of 5-75% to the signal light, and the 3 dB bandwidth of the reflective spectrum is 1-200 nm.

Further, the high-gain optical fiber is a highly rare earth luminescent ion doped optical fiber with a gain per unit length greater than 1 dB/cm; and a doping type of ions of the highly rare earth luminescent ion doped optical fiber comprises single doping, double doping and multi-doping of Yb³⁺, Er³⁺, Tm³⁺, Ho³⁺ and Dy³⁺.

Further, the pump source is a solid laser device, a semiconductor laser device or an optical fiber laser device, and a pump wavelength range of the pump source is 700-2000 nm.

Further, a splitting ratio of the small output port to the large output port of the optical coupler is 1/99-50/50.

Further, a free spectral range of the optical fiber etalon is 20-10000 GHz and a 3 dB transmissive bandwidth is smaller than 10 GHz.

Further, the optical fiber etalon is in a cascaded form of one or more optical fiber etalons.

Further, the SMS optical fiber structure apparatus is formed by welding a multi-mode optical fiber between two single-mode optical fibers, and a core diameter of the multi-mode optical fiber is 50-2000 μm, a cladding diameter of the multi-mode optical fiber is 100-2500 μm and a length of the multi-mode optical fiber is 0.01-500 cm.

Further, the SMS optical fiber structure apparatus is in a form of one or more multi-mode optical fibers that are cascaded.

Further, the stress loader is fixed onto the multi-mode optical fiber of the SMS optical fiber structure apparatus, and there are one or more stress loaders.

Compared with the prior art, the present invention has the technical effects that the high-reflectivity chirped optical fiber grating, the high-gain optical fiber and the low-reflectivity chirped optical fiber grating are connected in sequence to form the short linear resonant cavity portion; and the optical circulator, the optical fiber etalon and the SMS optical fiber structure apparatus form the ring cavity, and the stress loader is fixed onto the SMS optical fiber structure apparatus. Under a pumping action of a pump source and a frequency-selecting action of an optical fiber grating, a resonant cavity of the high-gain optical fiber realizes broadband spectrum laser light output first. A part of broadband spectrum laser light enters the ring cavity. On the one hand, comb spectrum laser light is generated by using the optical fiber etalon, and on the other hand, deformation such as stretching, compressing, bending and twisting are applied to the multi-mode optical fiber by loading stress to the SMS optical fiber structure apparatus. The transmissive wavelength of the SMS optical fiber structure apparatus is changed and the tunable filtering of the SMS optical fiber structure apparatus is realized by changing interference among a plurality of transverse modes, so that single wavelength laser light is selected; and then, the laser light is injected to return to the resonant cavity to inhibit oscillation of other wavelengths and compress the linewidth narrow to form single longitudinal mode (single-frequency) laser light, and finally, the single-frequency optical fiber laser output with stable power and wide tuning range is realized. The laser device in combination of a structural advantage of a compound cavity has the advantages of all fiber structure, wide wavelength tuning range and the like, and may be widely applied to the fields of optical communication, sensing, spectroscopy and the like.

### BRIEF DESCRIPTION OF THE DRAWINGS

FIG. 1 is a schematic diagram in which a stress loader applies stress to a multi-mode optical fiber to generate tensile deformation.

FIG. 2 is a schematic diagram in which a stress loader applies stress to a multi-mode optical fiber to generate compressive deformation.

FIG. 3 is a schematic diagram in which a stress loader applies stress to a multi-mode optical fiber to generate bending deformation.

FIG. 4 is a schematic diagram in which a stress loader applies stress to a multi-mode optical fiber to generate twisting deformation.

FIG. 5 is a principle schematic diagram of a multi-mode interference effect-based wide tunable single-frequency optical fiber laser device of the present invention.

In the drawings, 1—high-reflectivity chirped optical fiber grating; 2—high-gain optical fiber; 3—low-reflectivity chirped optical fiber grating; 4—pump source; 5—optical wavelength division multiplexer; 6—optical coupler; 7—opto-isolator ; 8—optical circulator; 9—optical fiber etalon; 10—SMS optical fiber structure apparatus; 11—stress loader.

### DESCRIPTION OF THE EMBODIMENTS

Further description will be made on specific implementation modes of the present invention below in combination with drawings and specific examples. It is to be noted that the claimed scope of protection of the present invention is not limited to the scope represented by the embodiments. The processes which are not specifically described below are realized by those skilled in the art with reference to the prior art.

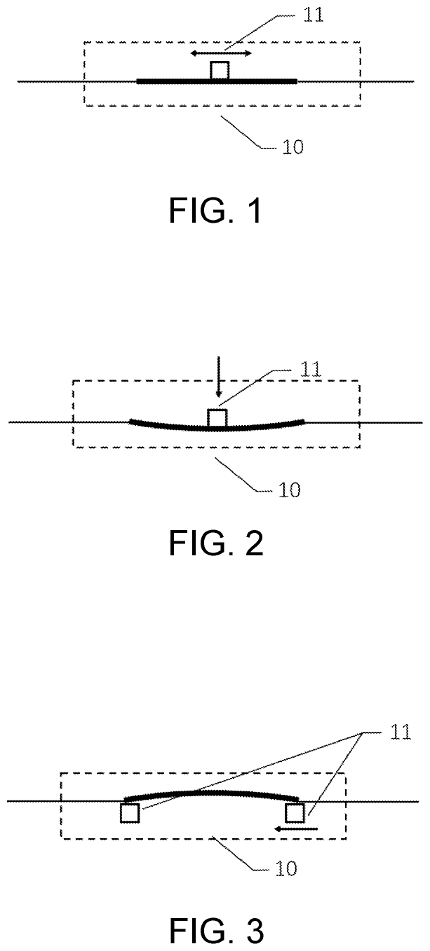

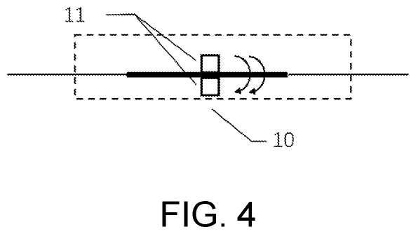

There are different modes to apply stress by the stress loader to generate deformation in the embodiments of the present invention. As shown in FIG. 1 to FIG. 4, a direction of stress applied by the stress loader is consistent with a length direction of the multi-mode optical fiber, so that tensile deformation is generated (FIG. 1); or the direction of stress applied by the stress loader is vertical to the length direction of the multi-mode optical fiber, so that compressive deformation is generated (FIG. 2); or the stress is applied by the stress loader, so that two ends of the multi-mode optical fibers are close to each other to generate bending deformation (FIG. 3); or the stress is applied by the stress loader, so that the multi-mode optical fiber rotates to generate the twisting deformation (FIG. 4).

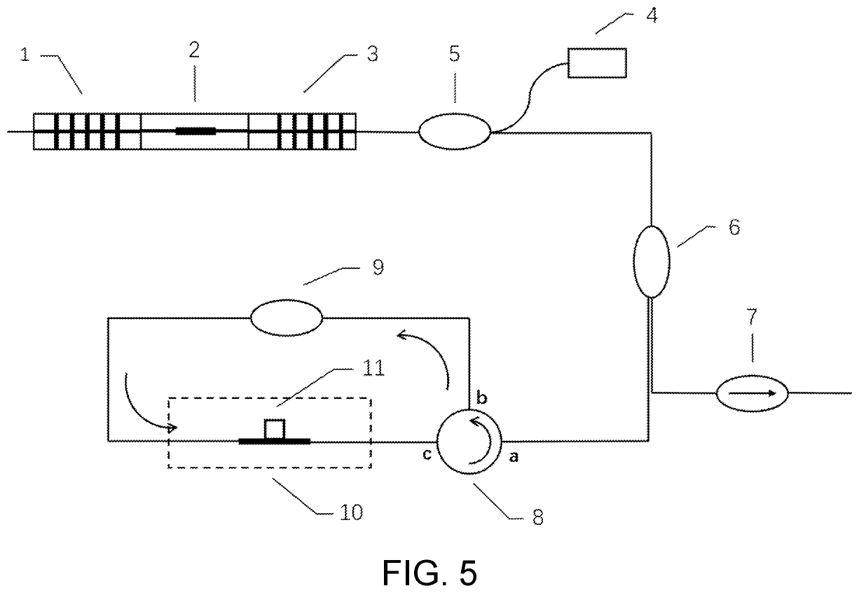

As shown in FIG. 5, it is the principle schematic diagram of the multi-mode interference effect-based wide tunable single-frequency optical fiber laser device in the embodiments of the present invention, including a high-reflectivity chirped optical fiber grating 1, a high-gain optical fiber 2, a low-reflectivity chirped optical fiber grating 3, a pump source 4, an optical wavelength division multiplexer 5, an optical coupler 6, an opto-isolator 7, an optical circulator 8, an optical fiber etalon 9, an SMS optical fiber structure apparatus 10, and a stress loader 11. One end of the high-gain optical fiber 2 is connected with one end of the high-reflectivity chirped optical fiber grating 1, another end of the high-gain optical fiber 2 is connected with one end of the low-reflectivity chirped optical fiber grating 3, and the three form a short linear resonant cavity portion; a pump end of the optical wavelength division multiplexer 5 is connected with a tail fiber of the pump source 4, a public end of the optical wavelength division multiplexer 5 is connected with another end of the low-reflectivity chirped optical fiber grating 3, a signal end of the optical wavelength division multiplexer 5 is connected with an input end of the optical coupler 6, a large output port of the optical coupler 6 is connected with a port a of the optical circulator 8, a port b of the optical circulator 8 is connected with an input end of the optical fiber etalon 9, an output end of the optical fiber etalon 9 is connected with one end of the SMS optical fiber structure apparatus 10, another end of the SMS optical fiber structure apparatus 10 is connected with a port c of the optical circulator 8, the stress loader 11 is fixed onto the SMS optical fiber structure apparatus 10, and a small output port of the optical coupler 6 is connected with an input end of the opto-isolator 7. Finally, optical fiber light generated by the short linear resonant cavity is output via the output port of the opto-isolator 7. The optical circulator 8, the optical fiber etalon 9 and the SMS optical fiber structure apparatus 10 form a ring cavity so as to form a compound cavity structure with the short linear resonant cavity in a self-injected locking form.

### Embodiment 1

A working wavelength of the high-reflectivity chirped optical fiber grating 1 of the embodiment is 1525-1565 nm, a 3 dB bandwidth of a reflective spectrum of the high-reflectivity chirped optical fiber grating is 40 nm, a center wavelength reflectivity of the high-reflectivity chirped optical fiber grating is 99.9% and a transmissivity of the high-reflectivity chirped optical fiber grating to pump light is 99.9%. A working wavelength of the low-reflectivity chirped optical fiber grating 3 of the embodiment is 1525-1565 nm, a 3 dB bandwidth of a reflective spectrum of the low-reflectivity chirped optical fiber grating is 40 nm, and a center wavelength reflectivity of the low-reflectivity chirped optical fiber grating is 60%. The high-reflectivity chirped optical fiber grating 1 and the low-reflectivity chirped optical fiber grating 3 form a functional module with wide spectral range selecting and filtering effects. The high-gain optical fiber 2 used in the embodiment is a highly doped Er3+ optical fiber. One end of the high-reflectivity chirped optical fiber grating 1, two ends of the high-gain optical fiber 2 and one end of the low-reflectivity chirped optical fiber grating 3 are coupled by tight abutting joint after end surfaces are ground and polished respectively. The pump source 4 used in the embodiment is a 980 nm single-mode semiconductor laser device. A splitting ratio of the optical coupler 6 used in the present embodiment is 5/95. The optical fiber etalon 9 used in the present embodiment is the optical fiber Fabry-Perot (F-P) etalon, a free spectral range of the optical fiber etalon is 100 GHz, a 3 dB transmissive bandwidth of the optical fiber etalon is 0.5 GHz, and a working wavelength range of the optical fiber etalon is 1520-1570 nm. According to the SMS optical fiber structure apparatus 10 used in the present embodiment, three cascaded multi-mode optical fibers with core diameters of 105 μm, cladding diameters of 125 μm and lengths of 5 cm are welded, a PZT is pasted to each of the three multi-mode optical fibers to form the stress loader 11, and the directions of the stress applied by the three PZT synchronously are vertical to the length direction of the multi-mode optical fiber, so that the multi-mode optical fiber generates compressive deformation. The input voltage ranges of the three PZT used in the present embodiment are all 0-150 V, and the deformability of the three PZT is 3.5 μm/100 V.

In the present embodiment, by taking a 1550 nm waveband as an example, the pump light generated by the pump source 4 is input from the low-reflectivity chirped optical fiber grating 3 through the pump end of the optical wavelength division multiplexer 5, and the pump light pumps highly doped rare earth luminescent ions in the high-gain optical fiber continuously, so that a population inversion state is realized. In combination with effects of the high-reflectivity chirped optical fiber grating and the low-reflectivity chirped optical fiber grating (endoscope), the light is subjected to stimulated emission to generate broadband spectrum output. After passing through the 5: 95 optical coupler 6, 95% of output laser light passes through the port a and the port b of the optical circulator and then enters the optical fiber F-P etalon to generate comb spectral laser light output. Then, only single wavelength laser light in the comb laser light is transmitted by means of the SMS optical fiber structure apparatus which plays a filtering role, passes through the port c and the port a of the optical circulator and the optical coupler 6 and is returned to the resonant cavity to inhibit oscillation of other wavelengths by enhancing oscillation of single wavelength and to compress linewidth narrow to form single longitudinal mode (single-frequency) laser light, and the single-frequency optical fiber laser light is output through the optical wavelength division multiplexer 5, the 5% output port of the optical coupler 6, and the opto-isolator 7 in sequence.

Then, by changing the working voltages of the three PZT synchronously, the PZT generate compressive deformation to apply compressive deformation to the multi-mode optical fiber in the SMS optical fiber structure apparatus, so that the transmissive wavelength of the multi-mode optical fiber changes, and the changing range of the wavelength is within 1520-1570 nm, for example, 1533.2 nm, 1545.2 nm, 1559.6 nm, 1562.0 nm and the like. Then, the wavelength is returned to the resonant cavity by way of injection to inhibit oscillation of other wavelengths and compress linewidth narrow so as to finally realize single-frequency optical fiber laser output that is freely tuned in 1525-1565 nm (wide tuning range) with stable power.

### Embodiment 2

A working wavelength of the high-reflectivity chirped optical fiber grating 1 of the present embodiment is 1850-2000 nm, a 3 dB bandwidth of a reflective spectrum of the high-reflectivity chirped optical fiber grating is 150 nm, a center wavelength reflectivity of the high-reflectivity chirped optical fiber grating is 99.9% and a transmissivity to pump light is 99.9%. A working wavelength of the low-reflectivity chirped optical fiber grating 3 of the present embodiment is 1850-2000 nm, a 3 dB bandwidth of a reflective spectrum of the low-reflectivity chirped optical fiber grating is 150 nm, and a center wavelength reflectivity of the low-reflectivity chirped optical fiber grating is 60%. The high-reflectivity chirped optical fiber grating 1 and the low-reflectivity chirped optical fiber grating 3 form a functional module with wide spectral range selecting and filtering effects. The high-gain optical fiber 2 used in the present embodiment is a highly doped Tm3+ optical fiber. One end of the high-reflectivity chirped optical fiber grating 1, two ends of the high-gain optical fiber 2 and one end of the low-reflectivity chirped optical fiber grating 3 are coupled by tight abutting joint after end surfaces are ground and polished respectively. The pump source 4 used in the present embodiment is a 793 nm single-mode semiconductor laser device. A splitting ratio of the optical coupler 6 used in the present embodiment is 5/95. The optical fiber etalon 9 used in the present embodiment is the optical fiber F-P etalon, a free spectral range of optical fiber etalon is 100 GHz, a 3 dB transmissive bandwidth of optical fiber etalon is 0.5 GHz, and a working wavelength range of optical fiber etalon is 1850-2000 nm. According to the SMS optical fiber structure apparatus 10 used in the present embodiment, two cascaded multi-mode optical fibers with core diameters of 105 μm, cladding diameters of 125 μm and lengths of 5 cm are welded, the optical fiber displacement tables are loaded respectively to the two multi-mode optical fibers to form the stress loaders 11, and the two optical fiber displacement tables apply stress synchronously, so that two ends of the multi-mode optical fiber are close to each other to generate bending deformation. Variable lengths of the two optical fiber displacement tables used in the present embodiment are 20 cm.

In the present embodiment, by taking a 1950 nm waveband as an example, the pump light generated by the pump source is input from the low-reflectivity chirped optical fiber grating through the pump end of the optical wavelength division multiplexer, and the pump light pumps highly doped rare earth luminescent ions in the high-gain optical fiber continuously, so that a population inversion is realized. In combination with effects of the high-reflectivity chirped optical fiber grating and the low-reflectivity chirped optical fiber grating (endoscope), the light is subjected to stimulated emission to generate broadband spectrum output. After passing through the 5: 95 optical coupler, 95% of output laser light passes through the port a and the port b of the optical circulator and then enters the optical fiber F-P etalon to generate comb spectral laser light output. Then, only single wavelength laser light in the comb laser light is transmitted by means of the SMS optical fiber structure apparatus which plays a filtering role, passes through the port c and the port a of the optical circulator and the optical coupler and is returned to the resonant cavity to inhibit oscillation of other wavelengths by enhancing oscillation of single wavelength and compress linewidth narrow to form single longitudinal mode (single-frequency) laser light, and the single-frequency optical fiber laser light is output through the optical wavelength division multiplexer, the 5% output port of the optical coupler, and the opto-isolator in sequence.

Then, by synchronously moving movable ends of the two optical fiber displacement tables, distances between fixed ends and the movable ends of the optical fiber displacement tables are shortened by 0-1 mm, and bending deformation is applied to the multi-mode optical fiber in the SMS optical fiber structure apparatus, so that the transmissive wavelength of the multi-mode optical fiber changes, and the changing range of the wavelength is within 1850-2000 nm, for example, 1860.5 nm, 1902.4 nm, 1950.1 nm, 1980.2 nm and the like. Then, the wavelength is returned to the resonant cavity by way of injection to inhibit oscillation of other wavelengths and compress linewidth narrow so as to finally realize single-frequency optical fiber laser output that is freely tuned in 1850-2000 nm (wide tuning range) with stable power.

The above is merely preferred embodiments of the present invention and is not limitation to the present invention in any form. Any equivalent changes, modifications or deviations made to the embodiments by those skilled in the art according to the technical scheme shall fall within the scope of the technical scheme of the present invention.

1. A multimode interference effect-based wide tunable single-frequency optical fiber laser device, comprising a high-reflectivity chirped optical fiber grating, a high-gain optical fiber, a low-reflectivity chirped optical fiber grating, a pump source, an optical wavelength division multiplexer, an optical coupler, an opto-isolator, an optical circulator, an optical fiber etalon, an SMS optical fiber structure apparatus and a stress loader, wherein one end of the high-gain optical fiber is connected with one end of the high-reflectivity chirped optical fiber grating, another end of the high-gain optical fiber is connected with one end of the low-reflectivity chirped optical fiber grating, and the three form a short linear resonant cavity; a pump end of the optical wavelength division multiplexer is connected with a tail fiber of the pump source, a public end of the optical wavelength division multiplexer is connected with another end of the low-reflectivity chirped optical fiber grating, a signal end of the optical wavelength division multiplexer is connected with an input end of the optical coupler, a large output port of the optical coupler is connected with a port a of the optical circulator, a port b of the optical circulator is connected with an input end of the optical fiber etalon, an output end of the optical fiber etalon is connected with one end of the SMS optical fiber structure apparatus, another end of the SMS optical fiber structure apparatus is connected with a port c of the optical circulator, the stress loader is fixed onto the SMS optical fiber structure apparatus, a small output port of the optical coupler is connected with an input end of the opto-isolator, and finally, optical fiber light generated by the short linear resonant cavity is output via an output port of the opto-isolator, wherein the optical circulator, the optical fiber etalon and the SMS optical fiber structure apparatus form a ring cavity so as to form a compound cavity structure with the short linear resonant cavity in a self-injected locking form.

2. The wide tunable single-frequency optical fiber laser device as claimed in claim 1, wherein the high-reflectivity chirped optical fiber grating has a transmissivity greater than 80% to a wavelength of pump light and a reflectivity greater than 80% to a wavelength of signal light, and 3 dB bandwidth of a reflective spectrum is 1-200 nm; and the low-reflectivity chirped optical fiber grating has a reflectivity of 5-75% to the signal light, and the 3 dB bandwidth of the reflective spectrum is 1-200 nm.

3. The wide tunable single-frequency optical fiber laser device as claimed in claim 1, wherein the high-gain optical fiber is a highly rare earth luminescent ion doped optical fiber with a gain per unit length greater than 1 dB/cm; and a doping type of ions of the highly rare earth luminescent ion doped optical fiber comprises single doping, double doping and multi-doping of Yb³⁺, Er³⁺, Tm³⁺, Ho³⁺ and Dy³⁺.

4. The wide tunable single-frequency optical fiber laser device as claimed in claim 1, wherein the pump source is a solid laser device, a semiconductor laser device or an optical fiber laser device, and a pump wavelength range is 700-2000 nm.

5. The wide tunable single-frequency optical fiber laser device as claimed in claim 1, wherein a splitting ratio of the small output port to the large output port of the optical coupler is 1/99-50/50.

6. The wide tunable single-frequency optical fiber laser device as claimed in claim 1, wherein a free spectral range of the optical fiber etalon is 20-10000 GHz and a 3 dB transmissive bandwidth is smaller than 10 GHz.

7. The wide tunable single-frequency optical fiber laser device as claimed in claim 6, wherein the optical fiber etalon is in a cascaded form of one or more optical fiber etalons.

8. The wide tunable single-frequency optical fiber laser device as claimed in claim 1, wherein the SMS optical fiber structure apparatus is formed by welding a multi-mode optical fiber between two single-mode optical fibers, and a core diameter of the multi-mode optical fiber is 50-2000 μm, a cladding diameter of the multi-mode optical fiber is 100-2500 μm and a length of the multi-mode optical fiber is 0.01-500 cm.

9. The wide tunable single-frequency optical fiber laser device as claimed in claim 8, wherein the SMS optical fiber structure apparatus is in a form of one or more multi-mode optical fibers that are cascaded.

10. The wide tunable single-frequency optical fiber laser device as claimed in claim 1, wherein the stress loader is fixed onto the multi-mode optical fiber of the SMS optical fiber structure apparatus, and there are one or more stress loaders.
